(19) United States
(12) Patent Application Publication
(10) Pub. No.: US 2012/0016090 A1
(43) Pub. Date: Jan. 19, 2012

(54) PROCESS FOR INCREASING THE MOLECULAR WEIGHT OF POLYESTERS

(75) Inventors: Robert LOOS, Ludwigshafen (DE); Simone Schillo, Ludwigshafen (DE)

(73) Assignee: BASF SE, Ludwigshafen (DE)

(21) Appl. No.: 13/183,646

(22) Filed: Jul. 15, 2011

Related U.S. Application Data
(60) Provisional application No. 61/365,364, filed on Jul. 19, 2010.

(51) Int. Cl. C08G 63/91

(52) U.S. Cl. 525/327.3

(57) ABSTRACT

The present invention relates to a process for increasing the molecular weight of polyesters via heating, to from 160 to 350° C., in an extruder, of 100 parts of polyester with i) from 0.01 to 5 parts of a tetracarboxylic dianhydride and ii) from 0.01 to 5 parts of a copolymer which contains epoxy groups and which is based on styrene, acrylate, and/or methacrylate.

The present invention relates to a process for increasing the molecular weight of polyesters via heating, to from 160 to 350° C., in an extruder, of 100 parts of polyester with i) from 0.01 to 5 parts of a tetracarboxylic dianhydride and ii) from 0.01 to 5 parts of a copolymer which contains epoxy groups and which is based on styrene, acrylate, and/or methacrylate.

WO 03/066704 describes a copolymer which contains epoxy groups and which is based on styrene, acrylate, and/or methacrylate (component ii) as a suitable chain extender for polyesters such as polyethylene terephthalate (PETs) and polybutylene terephthalates (PBTs). The reclamation of the polyesters places stringent requirements upon the speed and efficiency of the means used for increasing molecular weight. The mere addition of component ii) described above to the recyclant does not always deliver the necessary molecular-weight increase. This process is moreover sometimes so slow as to be uneconomic.

EP 748346 describes the use of tetracarboxylic dianhydrides and of sterically hindered hydroxyphenylalkylphosphonic esters for increasing the molecular weight of polyesters or polyester mixtures. Again, the efficiency of this process can be further improved.

Surprisingly, it has now been found that the efficiency of component ii) can be raised substantially if a tetracarboxylic dianhydride (component i) is added. In particular, it has proven advantageous to comply with an addition sequence as follows: component i) is first added, and component ii) is added directly thereafter or after a delay (of from 5 to 600 seconds).

The term polyesters mainly means polyesters such as polyethylene terephthalates (PETs) and polybutylene terephthalates (PBTs), or a mixture of said polyesters with other polymers, examples being PBT/PA, PBT/PS, PBT/ASA, PBT/ABS, PBT/PC, PET/PC, PET/ABS, PBT/PET/PC, PBT/PC/ABS; the term also includes semiaromatic or aliphatic polyesters. Particular preference is given to PET and to PET recyclants and PBT recyclants. Efficient molecular-weight increase is particularly important here in order that the performance characteristics of the starting polymer can be retained.

In principle, it is also possible to use polyesters based on aliphatic and aromatic dicarboxylic acids and on aliphatic dihydroxy compounds, these being known as semiaromatic polyesters, or to use aliphatic polyesters derived from aliphatic dicarboxylic acids and from aliphatic diols. A feature common to said polyesters is that they are biodegradable to DIN EN 13432. It is, of course, also possible to use a mixture of a plurality of these polyesters.

In the invention, the term semiaromatic polyesters also means polyester derivatives, such as polyetheresters, polyesteramides, or polyetheresteramides. Among the suitable semiaromatic polyesters are linear non-chain-extended polyesters (WO 92/09654). Preference is given to chain-extended and/or branched semiaromatic polyesters. The latter are known from WO 96/15173 to 15176, or WO 98/12242, to which express reference is made. Mixtures of different semiaromatic polyesters can likewise be used. More recent developments that are of interest are based on renewable raw materials (see WO-A 2006/097353, WO-A 2006/097354, and also EP 08165372.7). The term semiaromatic polyesters in particular means products such as Ecoflex® (BASF SE) and Eastar® Bio, Origo-Bi® (Novamont).

The term aliphatic polyesters means polyesters derived from aliphatic C₂-C₁₂-alkanediols and from aliphatic C₄-C₃₆-alkanedicarboxylic acids, examples being polybutylene succinate (PBS), polybutylene adipate (PBA), polybutylene succinate adipate (PBSA), polybutylene succinate sebacate (PBSSe), polybutylene sebacate adipate (PBSeA), and polybutylene sebacate (PBSe), or corresponding polyesteramides. The aliphatic polyesters are marketed by Showa Highpolymers with trademark Bionolle®, and by Mitsubishi with trademark GSPIa®. More recent developments are described in EP 08165370.1.

The term aliphatic polyesters also includes cycloaliphatic polyesters, in particular cellulose esters such as cellulose acetate, cellulose acetate butyrate or cellulose butyrate.

The process can also use polyesters based on hydroxycarboxylic acids. By way of example, it is possible to use polylactic acid, polycaprolactone, or polyhydroxyalkanoates, such as 3-PHB, 4-PHB or PHB(V).

The molar mass (Mₙ) of the preferred polyesters prior to molecular-weight increase is generally from 100 to 100 000 g/mol, in particular in the range from 900 to 75 000 g/mol, preferably in the range from 1000 to 50 000 g/mol, their melting point being in the range from 60 to 300° C., preferably in the range from 80 to 150° C.

The term tetracarboxylic dianhydrides (component i) in particular means pyromellitic anhydride, 3,3′,4,4′-biphenyltetracarboxylic dianhydride, 3,3′,4,4′-benzophenonetetracarboxylic dianhydride, and 3,3′,4,4′-diphenyl ether tetracarboxylic dianhydride. Pyromellitic anhydride is particularly preferred.

The amounts added of the tetracarboxylic dianhydride are from 0.01 to 5 parts, preferably from 0.02 to 1 part, and with particular preference from 0.05 to 0.5 part, for every 100 parts of polyester.

Copolymers which contain epoxy groups and which are based on styrene, acrylate, and/or methacrylate (component ii) in particular have the following structural features. The units bearing the epoxy groups are preferably glycidyl (meth)acrylates. Copolymers that have proven advantageous have glycidyl methacrylate content greater than 20% by weight, particularly preferably greater than 30% by weight, and with particular preference greater than 50% by weight, of the copolymer. The epoxy equivalent weight (EEW) is preferably from 150 to 3000 g/equivalent in these polymers, and with particular preference from 200 to 500 g/equivalent. The average molecular weight (weight average) M_{w} of the polymers is preferably from 2000 to 25 000, in particular from 3000 to 8000. The average molecular weight (number average) Mₙ of the polymers is preferably from 400 to 6000, in particular from 1000 to 4000. Polydispersity (Q) is generally from 1.5 to 5. Copolymers of the abovementioned type containing epoxy groups are marketed by way of example as Joncryl® ADR by BASF Resins B.V. Particularly suitable chain extenders are Joncryl® ADR 4368, long-chain acrylates, as described in EP application number 08166596.0, and Cardura® E10 from Shell.

The amounts used of copolymers of the abovementioned type containing epoxy groups, based on 100 parts of polyester, are from 0.01 to 5 parts, preferably from 0.1 to 2 parts, and particularly preferably from 0.2 to 1 part.

The process of the invention can, if appropriate, be rendered still more efficient by using further additives.

Further addition of an acid scavenger can also be advantageous, after addition of components i) and ii). Acid scavengers that have proven particularly successful are compounds selected from the groups of bisoxazoline, polyoxazoline, carbodiimide, polymeric carbodiimide, dicaprolactam, polymeric caprolactam, bisoxazine, and polyoxazine, these being described in more detail in WO 2010/012695. In respect of said components, express reference is made to page 7, line 15 to page 8, line 24 of WO 2010/012695.

The polymer mixtures can also comprise the usual additions. This has no impact on the effect found here of stabilization of the melts of biopolymers via addition of copolymers containing epoxy groups. Examples of usual additions are nucleating agents, such as talc, chalk, carbon black, graphite, calcium stearate, or zinc stearate, poly-D-lactic acid, N,N′-ethylene-bis-12-hydroxystearamide, polyglycolic acid,
lubricants and antiblocking agents,
waxes,
antistatic agents,
other compatibilizers, such as silanes, maleic anhydride, fumaric anhydride, isocyanates, diacyl chlorides,
antifogging agents,
UV stabilizers, or
dyes,
fillers, such as glass fibers, starch—plasticized with plasticizer such as glycerol or sorbitol, or unplasticized—starch derivatives, cereals, cellulose derivatives, talc, chalk, carbon black, and graphite.

Test Methods

Intrinsic viscosities were measured in phenol/o-dichlorobenzene 1:1 to DIN EN ISO 1628, at 25° C., by using an M-II micro Ubbelohde device. Intrinsic viscosities are stated in cm³/g.
Capillary Constant: 0.09185
Measurement Temperature [° C.]: 5
Solvent: phenol/o-dichlorobenzene 1:1 (PODB)
Solvent Flow Time [s]: 28.54
Hagenbach Solvent Correction [s]: 0.01
Concentrations: 0.5 g of polymer for every 100 mL of solvent

The melt viscosity of the specimens as a function of time was determined based on ISO 6721-10, by using an SR2 shear-stress-controlled plate-on-plate rotation rheometer from Rheometric Scientific. The diameter of the plates was 25 mm and the distance between the plates was 1 mm. The shear stress set was 100 Pa, and the measurement time was 30 min, and the preheat period was 5 min. The respective measurement temperature is stated.

The melt flow index (melt volume rate=MVR) of the specimens was determined to ISO 1133.

Materials used:

Polyesters:
a) semiaromatic polyester with trademark Ecoflex® FBX 7011 (BASF SE)
b) RT 51 polyethylene terephthalate (from Kosa)
c) 120 kg of 1,4-butanediol, 91.3 kg of dimethyl terephthalate, and 0.2 kg of glycerol were completely transesterified using 0.2 kg of tetrabutyl orthotitanate as catalyst, with heating and removal of the methanol by distillation, and 77.5 kg of adipic acid were then admixed. The water was first removed by distillation at atmospheric pressure, and the polycondensation reaction was then completed at up to 250° C. with a final vacuum <10 mbar for 1.5 h, before the polymer was strand-pelletized. The acid number of the aliphatic-aromatic polyester was 1.2 and its intrinsic viscosity was 84.

Component i):
i-1) Pyromellitic dianhydride from Aldrich

Component ii):
ii-1) Joncryl® ADR 4368 from BASF Resins B.V.

The experiments were conducted in a DSM Xplore 15 Micro-compounder 2005. During the measurement process, the force (in Newtons) that acts on the base plate from the polymer melt is recorded. This force is proportional to the viscosity of the melt, and changes in melt viscosity can thus be directly observed on-line and recorded.

### INVENTIVE EXAMPLE 1

20 g of polyester a) were melted at 240° C. No rise in viscosity was observed after addition of 0.2 g of component i-1. After 30 seconds, 0.2 g of component ii-1 was metered into the mixture. After addition of ii-1, a marked rise in viscosity was observed, from 2600 to 6000 N within a period of about 4 minutes. The reaction mixture was maintained at 240° C. during the entire experiment.

### INVENTIVE EXAMPLE 2

20 g of polyester c) were melted at 240° C. No rise in viscosity was observed after addition of 0.2 g of component i-1. After 3 minutes, 0.2 g of component ii-1 was metered into the mixture. After addition of ii-1, a marked rise in viscosity was observed, from 200 to 1300 N within a period of about 4 minutes.

### INVENTIVE EXAMPLE 3

20 g of polyester c) were melted at 240° C. No rise in viscosity was observed after addition of 0.2 g of component i-1. After 3 minutes, 0.4 g of component ii-1 was metered into the mixture. After addition of ii-1, a marked rise in viscosity was observed, from 200 to 3500 N within a period of about 4 minutes.

### COMPARATIVE EXAMPLE 4

20 g of polyester a) were melted at 240° C. After addition of 0.2 g of component i-1, a reduction in viscosity was observed over a period of 15 minutes.

### COMPARATIVE EXAMPLE 5

20 g of polyester a) were melted at 240° C. 0.2 g of component ii-1 was added after 1 minute. During a period of 15 minutes, the melt exhibited only a slow rise in viscosity from 3600 to 4000 N.

### INVENTIVE EXAMPLE 6

20 g of polyester b) were melted at 280° C. No rise in viscosity was observed after addition of 0.06 g of component i-1. After 30 seconds, 0.1 g of component ii-1 was metered into the mixture. After addition of ii-1, a marked rise in viscosity was observed, from 1800 to 5400 N within a period of about 4 minutes.

### COMPARATIVE EXAMPLE 7

20 g of polyester b) were melted at 280° C. After addition of 0.06 g of component i-1, a reduction in viscosity was observed over a period of 15 minutes.

### COMPARATIVE EXAMPLE 8

20 g of polyester a) were melted at 240° C. 0.1 g of component ii-1 was added after 1 minute. During a period of 15 minutes, the melt exhibited only a slow rise in viscosity from 1800 to 2300 N.

Comparative examples 4 and 7 demonstrate impressively that mere addition of pyromellitic dianhydride (component i) leads to a molecular-weight reduction instead of an increase. In comparative examples 5 and 8, the mere addition of component ii) brings about at best a small molecular-weight increase. The examples of the invention show that combined addition of components i) and ii) brings about a rapid and efficient molecular-weight increase.

1. A process for increasing the molecular weight of polyesters via heating, to from 160 to 350° C., in an extruder, of 100 parts of polyester with i) from 0.01 to 5 parts of a tetracarboxylic dianhydride and ii) from 0.01 to 5 parts of a copolymer which contains epoxy groups and which is based on styrene, acrylate, and/or methacrylate.

2. The process according to claim 1, wherein addition of component ii) occurs after addition of component i).

3. The process according to claim 1, wherein the polyester is a polyethylene terephthalate.

4. The process according to claim 1, wherein the polyester is an aliphatic or aliphatic-aromatic polyester or a polymer mixture of said polyesters.

5. The process according to claim 1, wherein the tetracarboxylic dianhydride is pyromellitic anhydride.

6. The process according to claim 1, wherein the copolymer containing epoxy groups comprises, as epoxy unit, a glycidyl acrylate or glycidyl methacrylate.

7. The process according to claim 1, wherein the epoxy equivalent weight of the copolymer containing epoxy groups is from 150 to 3000 g/equivalent.
